(19) United States
(12) Patent Application Publication
(10) Pub. No.: US 2024/0364405 A1
(43) Pub. Date: Oct. 31, 2024

(54) METHODS AND APPARATUS OF MACHINE LEARNING BASED CHANNEL STATE INFORMATION (CSI) MEASUREMENT AND REPORTING

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/771,058

(22) Filed: Jul. 12, 2024

Related U.S. Application Data
(63) Continuation of application No. PCT/IB2023/050297, filed on Jan. 13, 2023.
(60) Provisional application No. 63/266,816, filed on Jan. 14, 2022.

(51) Int. Cl. H04B 7/06; H04B 17/309; H04B 17/318; H04W 24/10

(52) U.S. Cl. CPC H04B 7/0626; H04B 17/328; H04B 17/346; H04W 24/10

(57) ABSTRACT

Provided is a method for machine learning based CSI measurement and reporting. The method includes: receiving, by a terminal device, configuration information of a set of “N” CSI-RS resources; receiving, by the terminal device, “M” CSI RS resources out of the “N” CSI RS resources; performing, by the terminal device, a measurement on the “M” CSI-RS resources; and generating, by the terminal device, a beam measurement result for the “N” CSI-RS resources by applying a first neural network on a result of the measurement on the “M” CSI-RS resources.

### CROSS-REFERENCE TO RELATED APPLICATION(S)

This application is a continuation application of international application No. PCT/IB2023/050297, filed on Jan. 13, 2023, which claims the benefit of priority to U.S. Provisional Patent Application No. 63/266,816, filed Jan. 14, 2022, both of which are incorporated herein by reference in their entireties.

### TECHNICAL FIELD

The present disclosure relates to transmission resource measurement and reporting. More specifically, systems and methods for enabling machine learning based Channel State Information Reference Signal (CSI-RS) resource measurement and reporting as well as control signaling designs are provided.

### BACKGROUND

New Radio (NR) and fifth generation (5G) communication systems support communications in frequency range 2 (FR2). An NR system in FR2 is generally a multi-beam-based system, where a base station has multiple downlink transmission (Tx) beams that are available for downlink transmission and a terminal device has multiple reception (Rx) beams available for downlink transmission reception. For the uplink transmission, the terminal device may have multiple Tx beams available for transmission, and the base station may have multiple uplink Rx beams that are available for uplink reception. To support a proper communication, the base station and the terminal device must find the best pair of (base station) Tx beam and (terminal device) Rx beam. The NR introduces beam measurement and reporting in CSI framework to support a selection of best Tx beam and Rx beam.

To support beam measurement and reporting, the base station can send “N” CSI-RS resources or SSBs (Synchronization Signal and Physical Broadcast Channel Blocks) to the terminal device. Each CSI-RS resource or SSB can be applied with one base station Tx beam. The terminal device can measure L1-RSRP (Layer 1 Reference Signal Received Power) or L1-SINR (Layer 1 Signal to Interference Noise Ratio) on each CSI-RS resource or SSB. The L1-RSRP or L1-SINR measurement of each CSI-RS resource or SSB can be considered as the beam quality of that Tx beam applied to the corresponding CSI-RS resource or SSB. The terminal device can report the L1-RSRP or L1-SINR measurement of a few CSI-RS resources or SSBs to the base station.

In NR CSI framework, a terminal device can be configured with a resource setting where the terminal device is provided with a list of “N” CSI-RS resources for beam management and/or SSBs. The terminal device can be provided with a reporting configuration which can indicate the terminal device to measure the L1-RSRP or L1-SINR on those CSI-RS resources for beam management and/or SSBs configured in the resource setting and then report “K” CRIs (CSI-RS resource indicator) or SSBRIs (SS/PBCH block resource indicator) and corresponding L1-RSRP or L1-SINR measurement results.

### SUMMARY

The present disclosure is related to systems and methods for enabling machine learning based CSI-RS resource measurement and reporting. In some embodiments, a terminal device (or user equipment, UE) can be configured with beam measurement reporting on CSI-RS resources and/or SSBs. The terminal device can be requested to perform beam measurement and report a result based on one or more machine learning mechanisms/scheme/algorithms. The terminal device can be provided with configuration information including a first list of “N” CSI-RS resources for beam measurements. A base station (or gNB) can transmit “M (<N)” CSI-RS resources out of those “N” CSI-RS resources in the first list for the terminal device to measure.

The terminal device can be provided with configuration information of a first neural network (or a machine learning module) for calculating beam measurement metrics. The terminal device can be requested to input measurement results of these “M” CSI-RS resources into the first neural network so as to obtain the beam measurement results of all “N” CSI-RS resources. Then the terminal device can be requested to report beam measurement results and an indicator indicating “K” of those “N” CSI-RS resources (e.g., “K” CSI-RS resources are identified as more suitable candidates than others).

In some embodiments, the terminal device can be provided with configuration information of a second neural network. The terminal device can be requested to input the beam measurement results of all “M” CSI-RS resource into the second neural network. The terminal device can be requested to report the output of the second neural network to the base station. For example, the terminal device can be requested to report the beam measurement result of one CSI-RS resource and corresponding time stamp to the system (e.g., via the base station).

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic block diagram of a terminal device in accordance with one or more implementations of the present disclosure.

FIG. 3 is a flowchart of a method in accordance with one or more implementations of the present disclosure.

FIG. 4 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

One major drawback of the conventional method of beam measurement and reporting in NR CSI framework is a large time-frequency-resource overhead used to transmit the CSI-RS resources and/or SSBs for beam measurement. For instance, the base station can 64 Tx beams and the terminal device has 4 Rx beam. To support the measurement over all the Tx beams and Rx beams, the system needs to transmit 64 CSI-RS resources and each CSI-RS resource is repeated 4 times. Doing so would result in a total cost of 256 CSI-RS resource transmission instances. Spending so many time frequency resources for beam training would significantly reduce the amount of time frequency resource available for data transmission and thus consequentially impair an overall system efficiency. Therefore, improved systems and methods that can address the foregoing issues are desirable and beneficial.

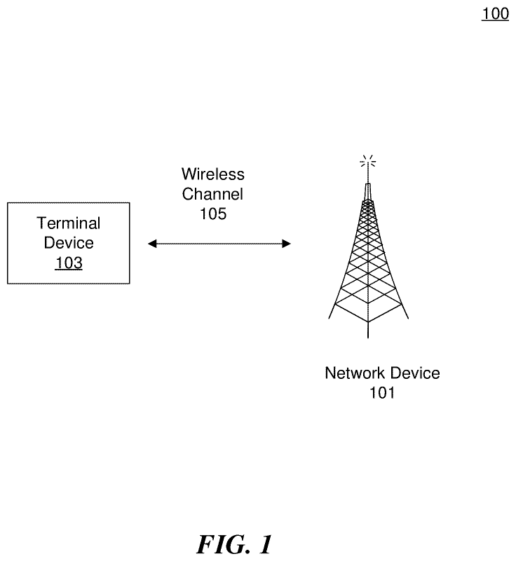

FIG. 1 is a schematic diagram of a wireless communication system 100 in accordance with one or more implementations of the present disclosure. The wireless communication system 100 can implement the methods discussed herein for beam failure detection and beam/link recovery. As shown in FIG. 1, the wireless communications system 100 includes a network device (or base station/cell) 101.

Examples of the network device 101 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 101 can include a relay station, an access point, an in-vehicle device, a wearable device, and the like. The network device 101 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as an NR system or network.

In FIG. 1, the wireless communications system 100 also includes a terminal device 103. The terminal device 103 can be an end-user device configured to facilitate wireless communication. The terminal device 103 can be configured to wirelessly connect to the network device 101 (via, e.g., via a wireless channel 105) according to one or more corresponding communication protocols/standards.

The terminal device 103 may be mobile or fixed. The terminal device 103 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 103 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only one network device 101 and one terminal device 103 in the wireless communications system 100. However, in some instances, the wireless communications system 100 can include additional network device 101 and/or terminal device 103.

The terminal device 103 can be provided with the configuration information of “N” gNB Tx beams, which can be “N” CSI-RS resources. The terminal device 103 can be provided with configuration of a first neural network. The terminal device 103 can be requested to first measure “M (<N)” CSI-RS resources out of those “N” CSI-RS resources and then the terminal device 103 can input the measurement results of those “M” CSI-RS resources to the first neural network to obtain the measurement results of all “N” CSI-RS resources. Then the terminal device 103 can be requested to report the measurement results of “K” CSI-RS resources, which are selected from those “N” CSI-RS resources (e.g., based on a predetermined threshold).

In some embodiments, the beam measurement of those “M” CSI-RS resource can be one or more of the followings: L1-RSRP measurement, L1-SINR measurement, L1-RSRQ measurement, hypothetical BLER (Block Error Rate), corresponding Rx beam(s) for each CSI-RS resource.

An output of the first neural network can be one or more of the following beam measurements for each CSI-RS resource: L1-RSRP measurement, L1-SINR measurement, L1-RSRQ measurement, corresponding Rx beam(s) for each CSI-RS resource.

In some embodiments, the terminal device 103 can be provided with configuration information of “N” gNB Tx beams, which can be “N” CSI-RS resources. The terminal device 103 can be provided with configuration information of a second neural network. The terminal device 103 can be requested to measure those “N” CSI-RS resources and then the terminal device 103 can input the measurement results of those “N” CSI-RS resources to the second neural network.

The terminal device 103 can be requested to report the output of the second neural network to the network device 101. Benefits of the foregoing arrangement include that the terminal device 103 can use the second neural network to obtain a low-overhead payload that can contain information of all the “N” CSI-RS resources. Accordingly, the terminal device 103 can report the beam measurement results with low overhead. In some embodiments, the measurement results on CSI-RS resource can include one or more of the followings: L1-RSRP measurement, L1-SINR measurement, hypothetical BLER (Block Error Rate) measurement of one CSI-RS resource, a channel estimation on each CSI-RS resource, etc.

In some implementations, the configuration information of the neural network for beam measurement can be provided by the network device 101 to the terminal device 103 and the terminal device 103 can apply the neural network according to the configuration provided by the network device 101. In another example, the configuration information of the neural network can be obtained by the terminal device 103. In such cases, the terminal device 103 can calculate the configuration information of the neural network based on measurement results on some CSI-RS resources and the relationships between those CSI-RS resources.

For example, the network device 101 can provide some assistance information of the neural network to the terminal device 103 and the terminal device 103 can calculate the configuration of the neural network based on the assistance information provided by the network device 101 and the measurement results of some CSI-RS resources or SSBs.

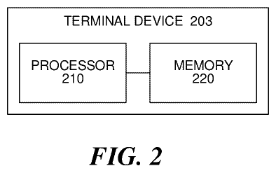

FIG. 2 is a schematic block diagram of a terminal device 203 (e.g., which can implement the methods discussed herein) in accordance with one or more implementations of the present disclosure. As shown, the terminal device 203 includes a processing unit 210 (e.g., a DSP, a CPU, a GPU, etc.) and a memory 220. The processing unit 210 can be configured to implement instructions that correspond to the methods discussed herein and/or other aspects of the implementations described above. It should be understood that the processor 210 in the implementations of this technology may be an integrated circuit chip and has a signal processing capability. During implementation, the steps in the foregoing method may be implemented by using an integrated logic circuit of hardware in the processor 210 or an instruction in the form of software. The processor 210 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 210 may be a microprocessor, or the processor 210 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 220, and the processor 210 reads information in the memory 220 and completes the steps in the foregoing methods in combination with the hardware thereof.

It may be understood that the memory 220 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

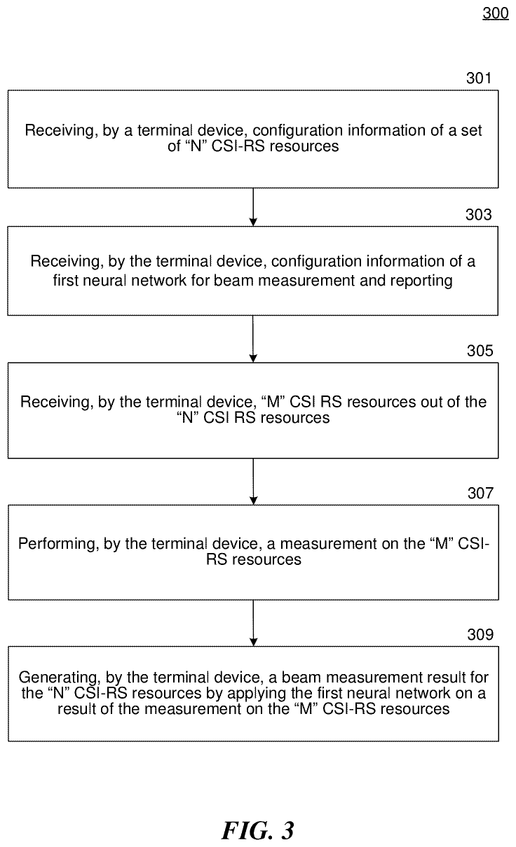

FIG. 3 is a flowchart of a method 300 in accordance with one or more implementations of the present disclosure. The method 300 can be implemented by a system (such as the wireless communications system 100). For example, the method 300 may also be implemented by the terminal device 103.

The method 300 includes, at block 301, receiving, by a terminal device, configuration information of a set of “N” CSI-RS resources. At block 303, the method 300 continues by receiving, by the terminal device, configuration information of a first neural network for beam measurement and reporting. In some embodiments, the configuration information can be calculated by the terminal device. In such cases, the method 300 can include calculating, by the terminal device, the configuration information of the first neural network for beam measurement and reporting based on the result of the measurement on the “M” CSI-RS resources.

In some embodiments, the method 300 can include receiving, by the terminal device, assistance information of the first neural network for the terminal device to calculate the configuration information of the first neural network.

At block 305, the method 300 continues by receiving, by the terminal device, “M” CSI RS resources out of the “N” CSI RS resources. At block 307, the method 300 continues by performing, by the terminal device, a measurement on the “M” CSI-RS resources. At block 309, the method 300 continues by generating, by the terminal device, a beam measurement result for the “N” CSI-RS resources by applying the first neural network on a result of the measurement on the “M” CSI-RS resources.

In some embodiments, the method 300 can include reporting, by the terminal device, the beam measurement result for the “N” CSI-RS resources to a base station. In some embodiments, the method 300 can include reporting, by the terminal device, an indicator indicating “K” CSI-RS resources of the “N” CSI-RS resources to the base station. In some embodiments, the “K” CSI-RS resources are selected by the terminal device according to a predetermined threshold.

In some embodiments, the method 300 can include reporting, by the terminal device, a time stamp associated with the “N” CSI-RS resources to a base station.

In some embodiments, the measurement on the “M” CSI-RS resources includes a Layer-1 Reference Signal Received Power (L1-RSRP) measurement, a Layer-1 Reference Signal Received Quality (L1-RSRQ) measurement, a Layer-1 Signal to Interference Noise Ratio (L1-SINR) measurement, a hypothetical Block Error Rate (BLER) measurement, and/or corresponding transmission (Tx) beams for the “M” CSI-RS resources.

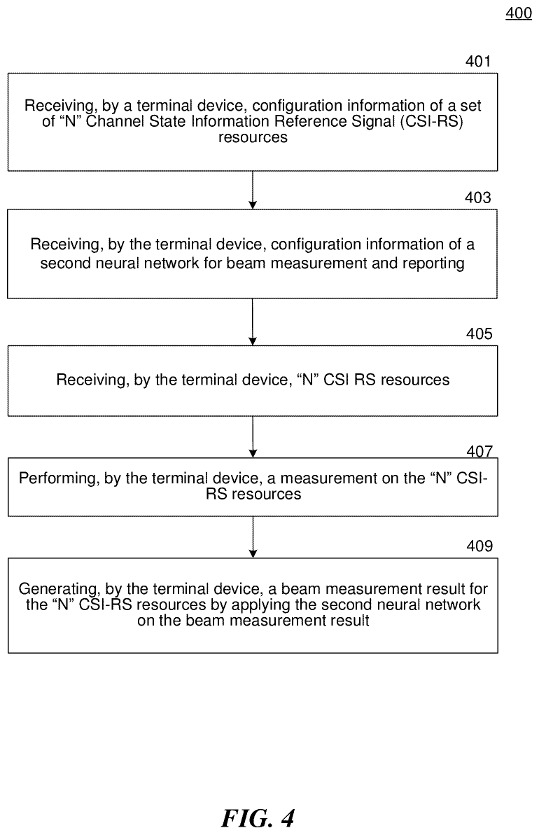

FIG. 4 is a flowchart of a method 400 in accordance with one or more implementations of the present disclosure. The method 400 can be implemented by a system (such as the wireless communications system 100). For example, the method 400 may also be implemented by the terminal device 103.

The method 400 includes, at block 401, receiving, by the terminal device, configuration information of a set of “N” Channel State Information Reference Signal (CSI-RS) resources.

At block 403, the method 400 continues by receiving, by the terminal device, configuration information of a second neural network for beam measurement and reporting.

At block 405, the method 400 continues by receiving, by the terminal device, “N” CSI RS resources. At block 407, the method 400 continues by performing, by the terminal device, a measurement on the “N” CSI-RS resources.

At block 409, the method 400 continues by generating, by the terminal device, a beam measurement result for the “N” CSI-RS resources by applying the second neural network on the beam measurement result.

In some embodiments, the method 400 can include reporting, by the terminal device, the beam measurement result for the “N” CSI-RS resources to a base station. In some embodiments, the method 400 can include reporting, by the terminal device, a time stamp associated with the “N” CSI-RS resources to a base station.

In some embodiments, the measurement on the “N” CSI-RS resources includes at least one of the following: an L1-RSRP measurement, an L1-RSRQ measurement, an L1-SINR measurement, a hypothetical BLER measurement, and corresponding Tx beams for the “N” CSI-RS resources.

In some embodiments, the method 400 can include receiving, by the terminal device, configuration information of the second neural network for beam measurement and reporting. In some embodiments, the method 400 can include calculating, by the terminal device, configuration information of the second neural network for beam measurement and reporting based on the result of the measurement on the “N” CSI-RS resources.

By the foregoing arrangements, the present systems and methods can effectively perform CSI-RS resource measurement and reporting in NR systems, by applying suitable machine learning processes.

One aspect of the present disclosure is that it provides methods supporting NR systems to use machine-learning based methods to obtain and report beam measurement results of large number of beams with low overhead. Accordingly, the NR systems can save more resource for data transmission and then an overall system efficiency (e.g., in FR2) is improved. Furthermore, the present methods and systems enable the NR systems to implement a large number of narrow Tx beam to extend a coverage of cell, which can further improve system performance.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### Additional Considerations

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the disclosure is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the disclosure are presented below in certain claim forms, the applicant contemplates the various aspects of the disclosure in any number of claim forms. Accordingly, the applicant reserves the right to pursue additional claims after filing this application to pursue such additional claim forms, in either this application or in a continuing application.

1. A method for machine learning based Channel State Information (CSI-RS) measurement and reporting, comprising:
receiving, by a terminal device, configuration information of a set of “N” CSI-RS resources;
receiving, by the terminal device, “M” CSI RS resources out of the “N” CSI RS resources;
performing, by the terminal device, a measurement on the “M” CSI-RS resources; and
generating, by the terminal device, a beam measurement result for the “N” CSI-RS resources by applying a first neural network on a result of the measurement on the “M” CSI-RS resources.

2. The method according to claim 1, further comprising:
reporting, by the terminal device, the beam measurement result for the “N” CSI-RS resources to a base station.

3. The method according to claim 1, further comprising:
reporting, by the terminal device, an indicator indicating “K” CSI-RS resources of the “N” CSI-RS resources to the base station.

4. The method according to claim 3, wherein the “K” CSI-RS resources are selected by the terminal device according to a predetermined threshold.

5. The method according to claim 1, further comprising:
reporting, by the terminal device, a time stamp associated with the “N” CSI-RS resources to a base station.

6. The method according to claim 1, wherein the measurement on the “M” CSI-RS resources includes at least one of: a Layer-1 Reference Signal Received Power (L1-RSRP) measurement, or a Layer-1 Reference Signal Received Quality (L1-RSRQ) measurement.

7. The method according to claim 1, wherein the measurement on the “M” CSI-RS resources includes at least one of: a Layer-1 Signal to Interference Noise Ratio (L1-SINR) measurement, a hypothetical Block Error Rate (BLER) measurement, or corresponding transmission (Tx) beams for the “M” CSI-RS resources.

8. The method according to claim 1, further comprising:
receiving, by the terminal device, configuration information of the first neural network for beam measurement and reporting.

9. The method according to claim 1, further comprising:
calculating, by the terminal device, configuration information of the first neural network for beam measurement and reporting based on the result of the measurement on the “M” CSI-RS resources.

10. The method according to claim 9, further comprising:
receiving, by the terminal device, assistance information of the first neural network for the terminal device to calculate the configuration information of the first neural network.

11. A system comprising:
a processor; and
a memory configured to store instructions, wherein the instructions, when executed by the processor, cause the processor to:
receive configuration information of a set of “N” Channel State Information Reference Signal (CSI-RS) resources;
receive “M” CSI RS resources out of the “N” CSI RS resources;
perform a measurement on the “M” CSI-RS resources; and
generate a beam measurement result for the “N” CSI-RS resources by applying a first neural network on a result of the measurement on the “M” CSI-RS resources.

12. The system according to claim 11, wherein the instructions, when executed by the processor, cause the processor to:
report the beam measurement result for the “N” CSI-RS resources to a base station.

13. The system according to claim 11, wherein the instructions, when executed by the processor, cause the processor to:
report an indicator indicating “K” CSI-RS resources of the “N” CSI-RS resources to the base station.

14. The system according to claim 13, wherein the “K” CSI-RS resources are selected by the system according to a predetermined threshold.

15. The system according to claim 11, wherein the instructions, when executed by the processor, cause the processor to:
report a time stamp associated with the “N” CSI-RS resources to a base station.

16. The system according to claim 11, wherein the measurement on the “M” CSI-RS resources includes at least one of: a Layer-1 Reference Signal Received Power (L1-RSRP) measurement, a Layer-1 Reference Signal Received Quality (L1-RSRQ) measurement, a Layer-1 Signal to Interference Noise Ratio (L1-SINR) measurement, a hypothetical Block Error Rate (BLER) measurement, or corresponding transmission (Tx) beams for the “M” CSI-RS resources.

17. The system according to claim 11, wherein the instructions, when executed by the processor, cause the processor to:
receive configuration information of the first neural network for beam measurement and reporting.

18. The system according to claim 11, wherein the instructions, when executed by the processor, cause the processor to:
calculate configuration information of the first neural network for beam measurement and reporting based on the result of the measurement on the “M” CSI-RS resources.

19. The system according to claim 18, wherein the instructions, when executed by the processor, cause the processor to:
receive assistance information of the first neural network for the terminal device to calculate the configuration information of the first neural network.

20. An integrated circuit chip, comprising an integrated logic circuit and/or one an instruction, wherein the integrated chip, when running the integrated logic circuit or the instruction, is caused to perform:
receiving configuration information of a set of “N” Channel State Information Reference Signal (CSI-RS) resources;
receiving “M” CSI RS resources out of the “N” CSI RS resources;
performing a measurement on the “M” CSI-RS resources; and
generating a beam measurement result for the “N” CSI-RS resources by applying a first neural network on a result of the measurement on the “M” CSI-RS resources.
